(19) United States
(12) Patent Application Publication
(10) Pub. No.: US 2010/0320898 A1
(43) Pub. Date: Dec. 23, 2010

(54) IMAGE DISPLAY APPARATUS

(75) Inventor: Kazuya Tsujino, Hiratsuka-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/783,667

(22) Filed: May 20, 2010

(30) Foreign Application Priority Data
Jun. 23, 2009 (JP) 2009-148633

(51) Int. Cl. H01J 1/62

(52) U.S. Cl. 313/498

(57) ABSTRACT

An image display apparatus includes: an electron-emitting electrode having a gate electrode a cathode electrode including a plurality of strip portions opposing to the gate electrode through a gap, wherein each gap functions as an electron emitting portion when a potential difference between a gate potential and a cathode potential is applied to the each gap; and a light-emitting member emitting light responsive to an irradiation with electrons emitted from an electron emitting portion. The plurality of the strip portions of the cathode electrode are arranged in a line along a predetermined direction. Intervals each between mutually adjacent strip portions of the cathode electrode are arranged such that the interval in a central region of the electron emitting portions is larger than that in a peripheral region thereof.

### BACKGROUND OF THE INVENTION

1. Field of the Invention

The present invention relates to an image display apparatus which has an electron-emitting electrode.

2. Description of the Related Art

In an image display apparatus having the electron-emitting electrode therein, electrons which have been emitted from the electron-emitting electrode provided on a rear plate fly in the inner part of the apparatus and collide against a light-emitting member provided on a face plate, the light-emitting member emits a light, and an image is thereby displayed. However, because an electric field in the inner part of the apparatus may change due to various reasons, an electron beam is occasionally deflected and may not accurately irradiate the light-emitting member which should be originally irradiated. This causes a change of a luminance gravity center, and can lead to the degradation of an image. An image display apparatus is known which has a spacer provided between a rear plate and a face plate, for instance. The spacer is provided for preventing a housing of the image display apparatus from being damaged by an air pressure or other pressures and holding a space between the rear plate and the face plate. The spacer is usually arranged at a space in a transverse direction so as not to be directly seen from the screen. However, the electrons collide against the spacer and thereby charge the spacer, which causes a change in the electric field in the proximity of the spacer and causes the above described problem.

As a countermeasure for such an image degradation, Japanese Patent Application Laid-Open No. 2002-520769 discloses a technology for reducing the image degradation originating in the deflection of the electron beam, by converging the electron beam. The image display apparatus described in Japanese Patent Application Laid-Open No. 2002-520769 has a plurality of element areas provided in each of an electron-emitting electrode (each pixel), and converges the electron beam to be emitted from each of the element areas by a converging structure for the electron beam. A structure like a partitioning plate which partitions each of the element areas is disclosed as the converging structure.

### SUMMARY OF THE INVENTION

An image display apparatus according to one embodiment of the present invention includes: an electron-emitting device having a gate electrode and a cathode electrode having a plurality of strip portions each arranged in opposition to the gate electrode to form a gap portion between the each of the strip portions and the gate electrode, wherein each of the gap portions functions as an electron emitting portion according to a potential difference between a gate potential applied to the gate electrode and a cathode potential applied to the cathode electrode; and a light-emitting member for emitting light responsive to an irradiation with an electron emitted from the electron emitting portion, wherein the plurality of strip portions are arranged in line along a predetermined direction, and a distance between the strip portions adjacent to each other in a center area in the electron-emitting device is longer than a distance between the strip portions adjacent to each other in a peripheral area in the electron-emitting device.

Because the plurality of the strip portions are arranged in the column, an intensity profile of electrons that irradiate a light-emitting member becomes a profile in which the intensity profiles of the electrons that have been emitted from each of the electron emitting portions are superimposed so as to be shifted from each other in an arrangement direction, when a section parallel to the arrangement direction has been observed. Thus superimposed profile tends to form a curve of an abrupt crest shape. This is because the number of the electron emitting portions which contribute to the irradiation is larger in the vicinity of the central part in the arrangement direction and the intensity tends to be high there. The fact that the profile forms the curve of the abrupt crest shape means that the luminance gravity center greatly changes when the region to be irradiated with electrons in the light-emitting member has been shifted by the deflection of the electrons. On the other hand, in the present invention, a space between the mutually adjacent strip portions in the end region of the electron-emitting electrode is made to be larger than that in the central region thereof. Thereby, the number of the electron emitting portions which contribute to the irradiation in the vicinity of the central part decreases, and on the contrary, the number of the electron emitting portions which contribute to the irradiation in the end of the profile increases, which flattens the form of the profile more as a whole. In other words, even when the region to be irradiated with electrons in the light-emitting member is shifted by the deflection of the electrons, the luminance gravity center results in changing little. Besides, the above described effect is obtained only by adjusting the spaces among the strip portions, and does not require an additional structural component.

Further features of the present invention will become apparent from the following description of exemplary embodiments with reference to the attached drawings.

### BRIEF DESCRIPTION OF THE DRAWINGS

FIG. 1 is a partially-ruptured perspective view illustrating one example of an image display apparatus according to the present invention.

FIG. 2 is a schematic sectional view illustrating a periphery of a spacer of the image display apparatus according to the present invention.

FIGS. 3A and 3B are schematic plan views illustrating an electron-emitting electrode according to the present invention.

FIGS. 4A, 4B and 4C are sectional views of the electron-emitting electrode illustrated in FIGS. 3A and 3B.

FIGS. 5A, 5B, 5C and 5D are views for describing a problem in a conventional technology.

FIG. 6 is a schematic plan view of an electron-emitting electrode in which an arrangement pitch of an electron emitting portion is uniform.

FIGS. 7A, 7B, 7C and 7D are views illustrating a relationship between an intensity profile of an electron beam and a luminance profile.

FIG. 8 is a view illustrating a change of a luminance gravity center with respect to a change of a barycentric position of an electron beam.

FIGS. 9A, 9B, 9C, 9D, 9E and 9F are process views for describing a method of manufacturing the electron-emitting electrode.

FIGS. 10A and 10B are schematic plan views of electron-emitting electrodes in Example and Comparative example.

### DESCRIPTION OF THE EMBODIMENTS

Preferred embodiments of the present invention will now be described in detail in accordance with the accompanying drawings.

The converging structure for the electron beam described in Japanese Patent Application Laid-Open No. 2002-520769 requires a dedicated structural member, and not only makes its structure complicated but also causes the aggravation of economical efficiency.

An object of the present invention is to provide an image display apparatus which has a simple composition and can reduce the change of a luminance gravity center originating in the deflection of the electron beam.

The present invention can provide an image display apparatus which has a simple composition and can reduce the change of the luminance gravity center due to the deflection of the electron beam.

The image display apparatus according to the embodiment of the present invention will be described below with reference to the drawings.

(Configuration of Image Display Apparatus)

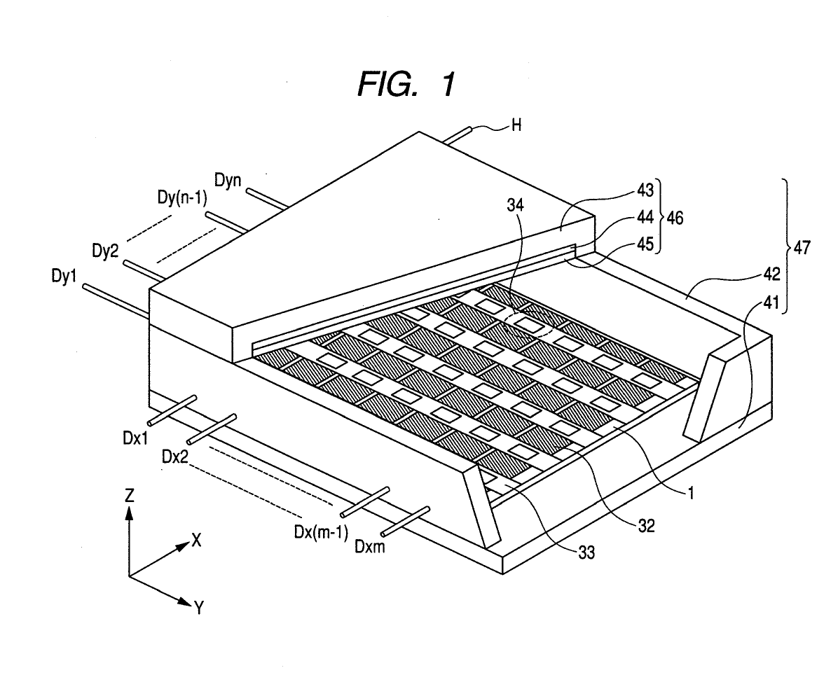

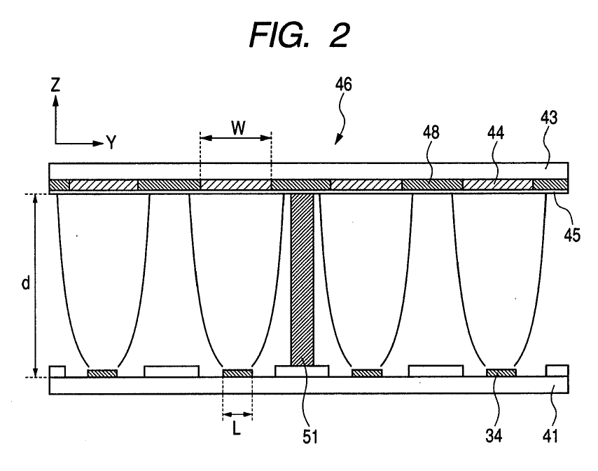

FIG. 1 is a perspective view illustrating one example of the structure of an image display apparatus according to one embodiment of the present invention, in which one part of the apparatus is cut away for illustrating the inner structure. FIG. 2 is a schematic sectional view illustrating the periphery of a spacer of an image display apparatus. A rear plate 41 which fixes a substrate 1 thereon and a face plate 46 are attached to a supporting frame 42 through frit glass or the like and constitute an envelope 47.

M lines of scanning lines 32 and n lines of modulation lines 33 are provided on the substrate 1. The m lines of the scanning lines 32 are connected to terminals Dx1 and Dx2 continued to Dxm respectively, and the n lines of the modulation lines 33 are connected to terminals Dy1 and Dy2 continued to Dxn (where m and n are both positive integer numbers). An unshown interlayer insulating layer is provided in between the m lines of the scanning lines 32 and the n lines of the modulation lines 33 to electrically separate the both lines from each other. In the intersections of the m lines of the scanning lines 32 and the n lines of the modulation lines 33, m×n pieces of electron-emitting electrodes 34 are formed in a matrix form.

The substrate 1 is an insulative substrate for mechanically supporting the above described electron emitting portion 34, lines 32 and 33 and the like thereon, and can employ a substrate of quartz glass, a glass containing a reduced amount of impurities such as Na, blue plate glass, silicon and the like. The substrate 1 desirably has not only a high mechanical strength but also resistances to dry etching, wet etching, an alkaline solution and an acid solution such as a liquid developer, as its necessary functions. When being employed as an integral product such as a display panel, the substrate also desirably has a small thermal expansion difference between the substrate and a film-forming material or another laminated member. The substrate 1 is desirably made from a material into which an alkali element and the like are difficult to diffuse from the inner part of the glass during heat treatment.

The face plate 46 has a glass substrate 43, and members such as a light-emitting member 44, a black matrix 48, and a metal back 45 which are formed in the inner face of the glass substrate. The light-emitting member 44 has a phosphor which emits light by being irradiated with electrons which have been emitted from the electron emitting portion 34 (which will be described later). The black matrix 48 is also referred to as a black member, and is formed in a matrix form. The respective black matrices define the outer edges of m×n pieces of light-emitting member 44 which are irradiated with electrons emitted from the corresponding electron-emitting electrode 34. The black matrix 48 prevents the color mixture of the phosphor, and enhances the contrast of an image by absorbing outside light. The metal back 45 has a function as an anode electrode, and is hereafter occasionally referred to as an anode 45. The metal back 45 is connected to a high-voltage terminal H, and a DC voltage, for instance, of 10 (kV) is supplied to the metal back 45 therethrough. This is an accelerating voltage for imparting a sufficient energy for exciting the phosphor of the light-emitting member 44 to electrons to be emitted from the electron-emitting electrode 34. Because the rear plate 41 is provided mainly for reinforcing the strength of the substrate 1, the additional rear plate 41 may be eliminated when the substrate 1 has sufficient strength by itself.

With reference to FIG. 2, a supporting member referred to as a spacer 51 is installed in between the face plate 46 and the rear plate 41 in order to give a sufficient strength against atmospheric pressure to the apparatus. As described above, the electrons collide against the spacer 51 and thereby charge the spacer 51, which change an electric field in the proximity of the spacer 51 and occasionally deflects the electron beam.

(Configuration of Electron-Emitting Electrode)

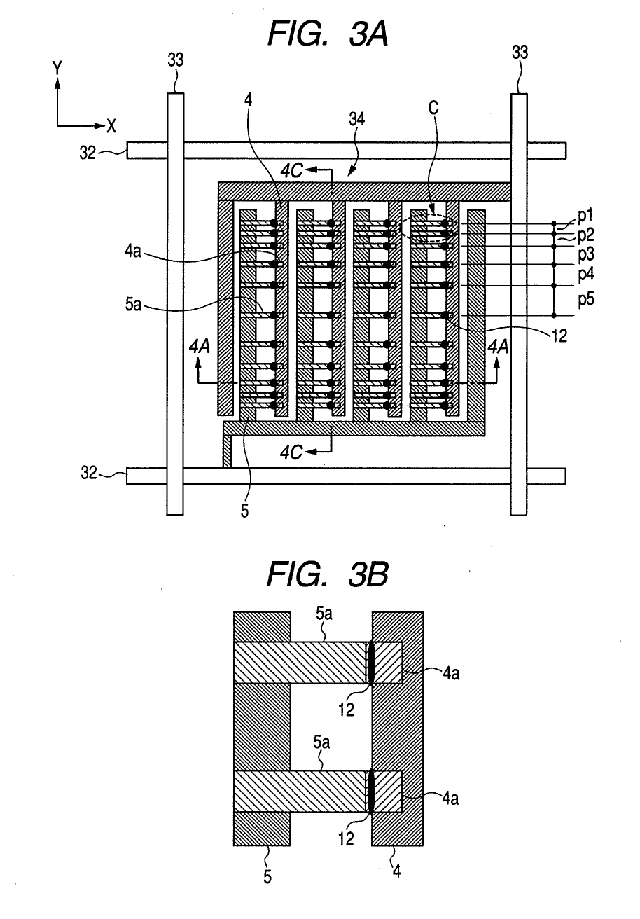

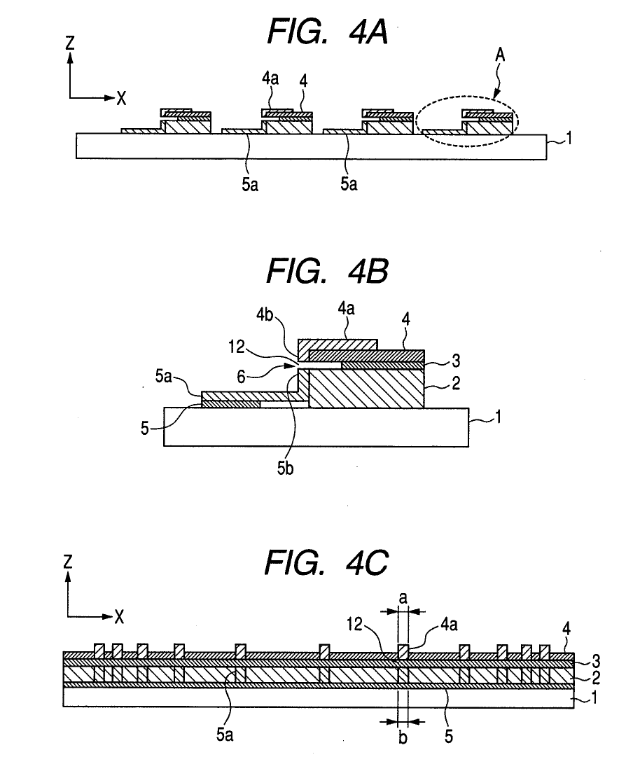

FIG. 3A is a schematic plan view illustrating one electron-emitting electrode, and FIG. 3B is an enlarged view of the portion C in FIG. 3A. FIG. 4A is a sectional view taken along the line 4A-4A of FIG. 3A, FIG. 4B is an enlarged view of the portion A in FIG. 4A, and FIG. 4C is a sectional view taken along the line 4C-4C of FIG. 3A. The electron-emitting electrode which can be applied to the present invention is not limited by embodiments which will be described below, but can adopt an arbitrary configuration such as a field-emission type like a Spindt type, an MIM type and a surface-conduction type.

Scanning lines 32 and modulation lines 33 are formed on a substrate 1 in a state of being insulated from each other, and a region surrounded by a pair of the mutually adjacent scanning lines 32 and a pair of the mutually adjacent modulation line 33 becomes an area of forming one electron-emitting electrode 34. A gate electrode 4 connected to the modulation line 33 is formed on the substrate 1, through the intermediary of a first insulating layer 2 and a second insulating layer 3. The gate potential is applied to the gate electrode from the modulation line 33. In addition, a cathode electrode 5 connected to the scanning line 32 is formed on the substrate 1. A cathode potential which is different from the gate potential is applied to the cathode electrode from the scanning line 32.

The cathode electrode 5 has a plurality of strip portions 5a of the cathode electrode thereon which are formed so as to have a comb-like shape. The strip portion 5a of the cathode electrode extends in a direction perpendicular to the cathode electrode 5, further rises on the way in a direction perpendicular to the substrate 1 along the first insulating layer 2, and reaches the tip part 5b. The gate electrode 4 has a plurality of protruding portions 4a of the gate electrode thereon, which are formed so as to form a comb-like shape. The protruding portion 4a of the gate electrode is branched from the gate electrode 4, extends in a direction perpendicular to the gate electrode 4 above the gate electrode 4, further descends on the way in a direction perpendicular to the substrate 1 along the corner of the gate electrode 4, and reaches the tip part 4b. The gate electrode 4 and the protruding portion 4a of the gate electrode can be also integrally formed as one member. The tip part 5b of the strip portion 5a of the cathode electrode is arranged so as to oppose to the corresponding gate electrode 4 through a gap 6.

The protruding portion 4a of the gate electrode is electrically connected to the gate electrode 4, and the strip portion 5a of the cathode electrode is electrically connected to the cathode electrode 5. Accordingly, a common gate potential is applied to each of the protruding portions 4a of the gate electrode from the modulation line through the gate electrode 4, and a common cathode potential is applied to each of the strip portions 5a of the cathode electrode from the scanning line 32 through the cathode electrode 5. For this reason, a potential difference between the gate potential and the cathode potential is applied to each of the gaps 6 between the strip portions 5a of the cathode electrode and the protruding portions 4a of the gate electrode, and thereby electrons are emitted from the gaps 6. In other words, the gap 6 functions as an electron emitting portion 12. In addition, as is clear from the above description, the electron-emitting electrode 34 has a plurality of the strip portions 5a of the cathode electrode.

The protruding portion 4a of the gate electrode and the strip portion 5a of the cathode electrode both extend in a strip shape toward the gap 6, and the width a of the protruding portion 4a of the gate electrode is smaller than the width b of the strip portion 5a of the cathode electrode, as is illustrated in FIG. 4C. Thereby, electrons which irradiate the side face of the protruding portion 4a of the gate electrode out of electrons which have been emitted from the strip portion 5a of the cathode electrode increase, and the probability of electrons which reach the anode 45 increases. As a result, electron emission efficiency (ratio of electric current passing to anode from cathode with respect to electric current passing to gate from cathode) can be increased.

A plurality of the strip portions 5a (electron emitting portions 12) are arranged in a line in a predetermined direction, and a space between the mutually adjacent strip portions 5a in the central region of the electron-emitting electrode 34 is larger than that in the end region thereof. In other words, a space (pitch) in a Y-direction between the mutually adjacent electron emitting portions 12 in the inner part of the electron-emitting electrode 34 becomes narrower in a more peripheral part of the electron-emitting electrode 34, and the space becomes wider in a more central part. In the present embodiment, arrangement pitches p1 to p5 between the electron emitting portions 12 have the relationship of p1<p2<p3<p4<p5.

Next, an effect for reducing the change in the position of the luminance gravity center of an electron beam in the present embodiment will be described below.

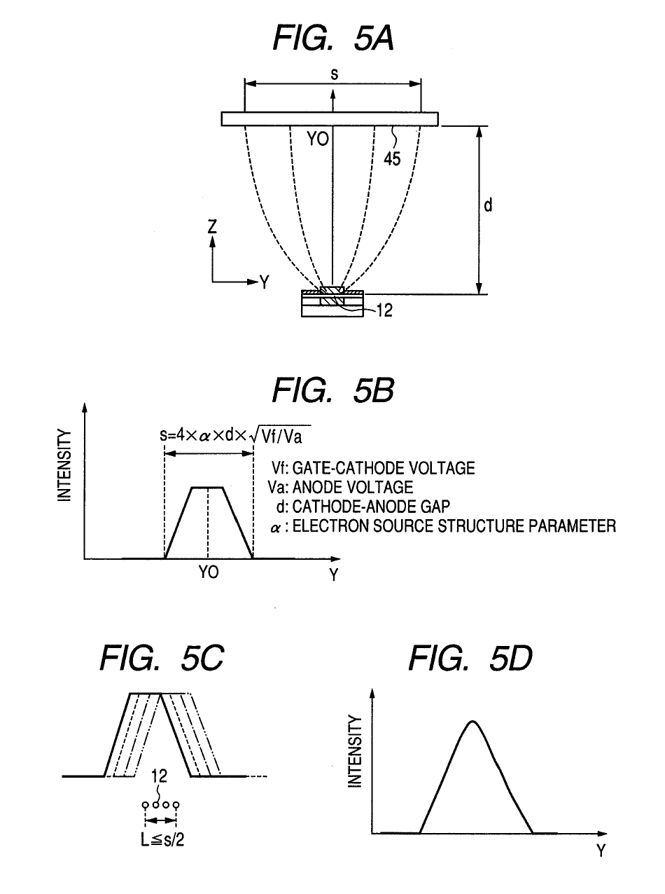

FIG. 5A is a view illustrating a trajectory in a Y-direction of electrons which have been emitted from an electron emitting portion 12 and reach an anode 45. The electrons which have been emitted from the electron emitting portion 12 reach the anode 45 while diverging as is shown by dashed lines. At this time, the intensity profile of the electron beam emitted from one electron emitting portion 12 at the anode 45 becomes a profile which is high in the central part Y0 of the electron emitting portion and is low in the peripheral part thereof, as is illustrated in FIG. 5B. An irradiated width s of the anode 45 with the electron beam is shown in FIG. 5B, and is expressed by Expression 1. Here, Vf represents a potential between a gate and a cathode, Va represents an anode potential, d represents a gap between the cathode and the anode (see FIG. 5A), and α is a parameter according to an electron source structure and is a value in a range of 0.3 to 1.

Expression 1

s=4×α×d×\sqrt{V f/V a}

When there are a plurality of the electron emitting portions 12 in the same electron-emitting electrode 34, the intensity profile of the electron beam emitted from the electron-emitting electrode 34 is expressed by the sum of the intensity profiles of the electron beams from each of the electron emitting portions (each of strip portions 5a). FIG. 5C illustrates the intensity profile of the electron beam when the electron emitting portions 12 (strip portion 5a) are arrayed at an equal space in the Y-direction in the same electron-emitting electrode 34, and a space L between the electron emitting portions 12 in both ends of the cathode electrode satisfies L≦s/2. Because the central part of each column of the electron emitting portions 12 in the same electron-emitting electrode 34 is irradiated with the electron beams emitted from all of the electron emitting portions 12 arrayed in a column, the intensity becomes the strongest. As the position moves to the peripheral part in each column of the electron emitting portions 12, the number of the electron emitting portions 12 which contribute to the irradiation by the electron beam decreases, so the intensity decreases. For this reason, the obtained intensity profile of the electron beam shows a sharp peak as illustrated in FIG. 5D.

If the L is larger than the s, the intensity profile does not become such a shape, but for this reason, it is necessary to increase the L or to decrease the s. In order to increase the L, it is necessary to increase the size of one pixel, which causes a problem when an image is highly refined. In order to decrease the s, there are units of decreasing a driving voltage, increasing an anode voltage, decreasing the distance between the cathode and the anode and the like, but all of the units are difficult subjects.

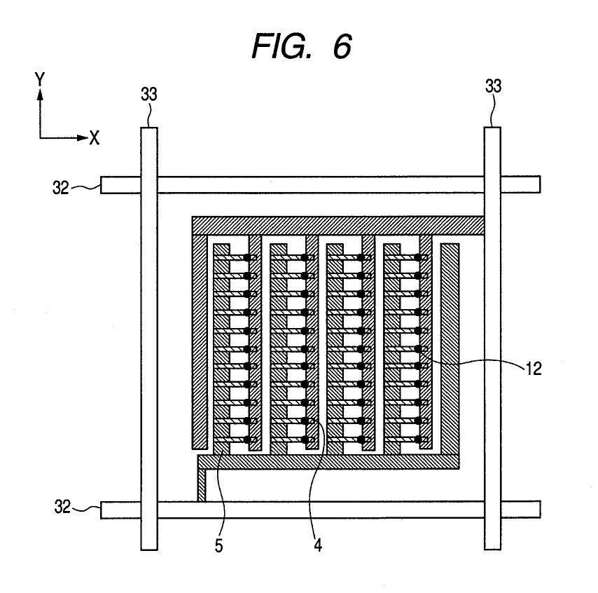

FIG. 6 illustrates a layout configuration in which the pitches among electron emitting portions are uniform, for comparison with the present embodiment. In this case, the intensity profile of the electron beam in a Y-direction becomes a shape formed by superimposing each intensity profile of the electron beam emitted from one electron emitting portion illustrated in FIG. 5B, according to the pitch and the number of the electron emitting portions in the Y-direction.

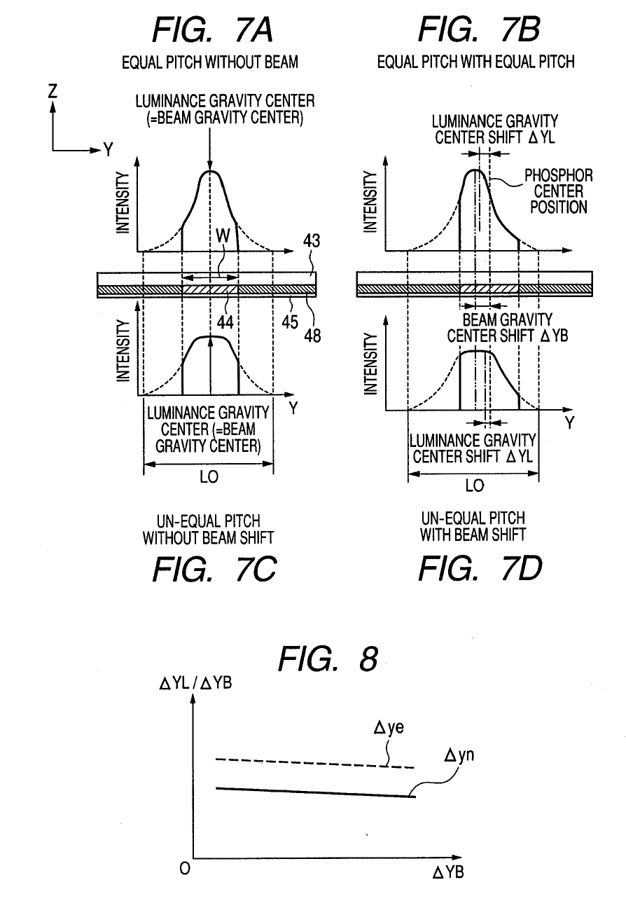

FIG. 7A illustrates a profile in the Y-direction in the case where there is no shift (deflection) of the electron beam in the electron-emitting electrode of FIG. 6, and FIG. 7B illustrates a profile in the Y-direction in a case where there is a shift of the electron beam thereof. FIG. 7C illustrates a profile in the Y-direction in a case where there is no shift of the electron beam in the electron-emitting electrode of FIGS. 4A to 4C, and FIG. 7D illustrates a profile in the Y-direction in a case where there is a shift of the electron beam thereof. The solid line illustrates a luminance profile drawn in consideration of the width w of the light-emitting member 44 in the Y-direction, and the dotted line illustrates the intensity profile of the electron beam. In FIGS. 7B and 7D, the electron beam is shifted toward a left direction of the drawings compared to FIGS. 7A and 7C. It was supposed that the luminance was proportional to the intensity of the electron beam. The intensity profile of the electron beam and the luminance profile are different from each other due to the scattering of electrons in the inner part of the light-emitting member 44. However, the influence of the scattering is not taken into consideration because the scattering does not affect the conclusion.

Because the electron beam which has hit the black matrix 48 is not converted into light, the intensity profile (dotted line) of the electron beam results in being different from the luminance profile (solid line). The amount of the shift of the luminance gravity center from the central position of the light-emitting member 44 shall be represented by ΔYL, and the amount of the shift of the electron beam intensity gravity center from the central position of the light-emitting member 44 shall be represented by ΔYB. The smaller is the ΔYL/ΔYB, the smaller is the change of the luminance gravity center from the central position of the light-emitting member with respect to the change of the electron beam intensity gravity center, which results in reducing the degradation of an image quality.

The ΔYL/ΔYB varies also depending on an anode voltage, a distance between the face plate and the rear plate, a length of the electron-emitting electrode, a width of the light-emitting member 44 and the like. However, the factors were supposed to be invariant, and the difference of the ΔYL/ΔYB only due to the difference of the electron-emitting electrode arrangement pitch was confirmed.

Suppose that the ΔYL/ΔYB in FIG. 7B is represented by Δye and the ΔYL/ΔYB in FIG. 7D is represented by Δyn. The change of each value at this time according to ΔYB is illustrated in FIG. 8. It is understood that Δye is larger than Δyn when ΔYB is in a range of 0 to a certain value, and the layout configuration of FIGS. 4A to 4C show a higher effect of reducing the degradation of the image quality. In addition, a ratio p5/p1 of a pitch p5 in the central part of the electron emitting portion 12 of FIGS. 4A to 4C to a pitch p1 in the peripheral part thereof in FIGS. 4A to 4C can be set 2 to 40.

Although it is clear from the above-mentioned description, the length L0 of an irradiated area in the light-emitting member with electrons emitted from the electron-emitting electrode 34, in an arrangement direction of the strip portion 5a of the cathode electrode, is longer than the length (=width w) of the light-emitting member in the arrangement direction of the strip portion 5a of the cathode electrode. By this configuration, the effect that the change of the luminance gravity center becomes smaller than that of the intensity profile of the electron beam is obtained.

Thus, because the electron beam intensity is determined by the arrangement pitch of the electron emitting portion, the intensity of electron beams emitted from the periphery can be increased by making the arrangement pitch of the periphery smaller than the arrangement pitch of the central part, and the whole intensity profile of the electron beam can be smoothened. Accordingly, a change in the luminance gravity center with respect to the deflection of the electron beam can be mitigated.

(Method for Manufacturing Electron-Emitting Electrode)

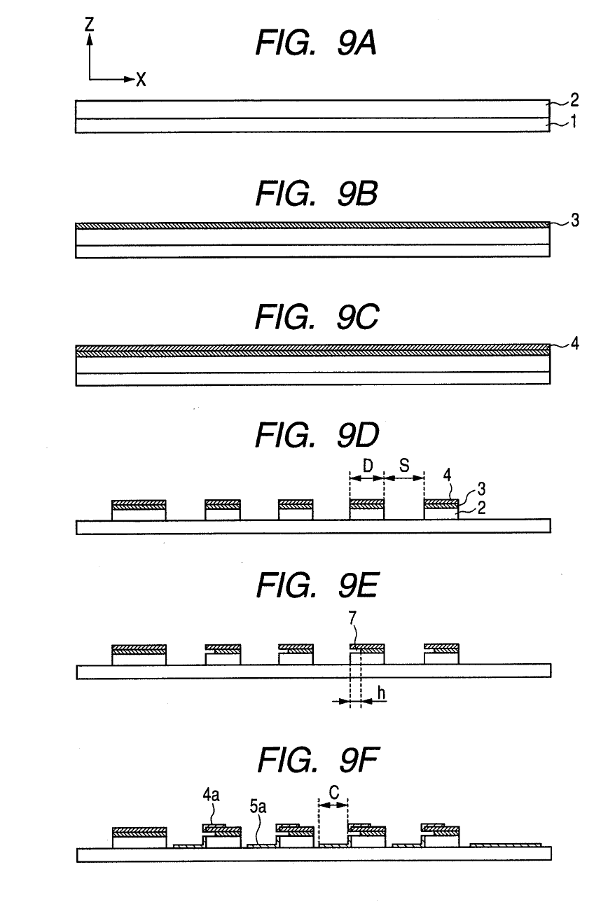

Next, a method of manufacturing the electron-emitting electrode described above will be described with reference to FIGS. 9A to 9F.

As shown in FIG. 9A, an insulating layer 2 is laminated on a substrate 1. The insulating layer 2 is a layer which becomes the 1st insulating layer 2 later. The insulating layer 2 is an insulative film made from a material which is excellent in workability and is SiN(SiₓN_{y}) or SiO₂, for instance. The insulating layer 2 is formed with a general vacuum film-forming method such as a sputtering method, a CVD method or a vacuum deposition method.

Next, as illustrated in FIG. 9B, an insulating layer 3 is formed on the insulating layer 2 with the general vacuum film-forming method such as a sputtering method, a CVD method and a vacuum deposition method. The insulating layer 3 is a layer which becomes the 2nd insulating layer 3 later. The thicknesses of the insulating layer 2 and the insulating layer 3 are set in a range of 5 nm to 50 μm, and can be selected from a range of 50 nm to 500 nm, respectively. The insulating layer 2 and the insulating layer 3 can select such materials as to have a different etching speed in etching from each other. The selection ratio of the insulating layer 2 and the insulating layer 3 is desirably 10 or more, and is desirably 50 or more, if being possible. Specifically, for instance, SiₓN_{y} can be used for the insulating layer 2, and insulative materials such as SiO₂, a PSG film with a high phosphorus concentration, a BSG film with a high boron concentration or the like can be used for the insulating layer 3.

Next, as illustrated in FIG. 9C, an electroconductive layer 4 is formed on the insulating layer 3. The electroconductive layer 4 is a layer which becomes a gate electrode 4 later. The electroconductive layer 4 is formed with a general vacuum film-forming technology such as a vapor deposition method and a sputtering method. It is desirable that the material of the electroconductive layer 4 has high thermal conductivity in addition to high electroconductivity and has a high melting point. The materials include, for instance: metals such as Be, Mg, Ti, Zr, Hf, V, Nb, Ta, Mo, W, Al, Cu, Ni, Cr, Au, Pt and Pd, or alloy materials thereof; and carbides such as TiC, ZrC, HfC, TaC, SiC and WC. The materials also include: borides such as HfB₂, ZrB₂, CeB₆, YB4 and GdB4; nitrides such as TiN, ZrN, HfN and TaN; semiconductors such as Si and Ge; and organic polymer materials. The materials further include amorphous carbon, graphite, diamond like carbon, carbon having diamond dispersed therein, and carbon compounds. The material is appropriately selected from the above materials. The thickness of the electroconductive layer 4 is set in a range of 5 nm to 500 nm, and can be selected from a range of 50 nm to 500 nm.

Next, as illustrated in FIG. 9D, a resist pattern is formed on the electroconductive layer 4 with a photolithographic technology, and then, the electroconductive layer 4, the insulating layer 3 and the insulating layer 2 are sequentially processed by using an etching technique. Thereby, the gate electrode 4, the 2nd insulating layer 3 and the 1st insulating layer 2 are obtained. In such an etching process, RIE (Reactive Ion Etching) is generally used which can precisely etch a material by converting an etching gas into plasma and irradiating the material with the plasma. As for a processing gas, when the member to be processed forms a fluoride, a fluorine-based gas of CF₄, CHF₃ and SF₆ is selected. When the member to be processed forms a chloride as Si and Al do, a chlorine gas such as Cl₂ and BCl₃ is selected. In order to secure a selection ratio of the above member to the resist, to secure the smoothness of the etched surface, or to increase an etching speed, gaseous hydrogen, oxygen, argon or the like is added whenever necessary. This etching operation may be stopped right before the upper surface of the substrate 1 is etched, or a part of the substrate 1 may be etched. The number of the gate electrode 4 (electron-emitting electrode) to be arranged in the X-direction, the width D of the gate electrode 4 in the X-direction, and a space S between adjacent gate electrodes 4 in the X-direction can be appropriately determined. The width D can be in a range of several μm to several tens of μm.

Next, as illustrated in FIG. 9E, a recess part 7 is formed in one side face of a layered body formed of the gate electrode 4, the 2nd insulating layer 3 and the 1st insulating layer 2, by removing one part of only the 2nd insulating layer 3 with the use of an etching technique. When the 2nd insulating layer 3 is made from a material of SiO₂, for instance, a mixture solution of ammonium fluoride and fluoric acid can be used for etching, which is commonly referred to as a buffer hydrofluoric acid (BHF). When the 2nd insulating layer 3 is a material formed of SiₓN_{y}, the 2nd insulating layer 3 can be etched with a phosphoric-acid-based hot etching solution. The depth of the recess part 7, which is specifically a distance h between the side face of the 2nd insulating layer 3 and the side face of the 1st insulating layer 2, can be about 30 nm to 200 nm. In the present example, the 1st insulating layer 2 and 2nd insulating layer 3 are stacked, but the present invention is not limited to the present example, and the recess part 7 may be formed by removing one part of one insulating layer.

Next, as illustrated in FIG. 9F, an electroconductive material is deposited on the substrate 1 and the side face of the 1st insulating layer 2. At this time, the electroconductive material also deposits on the gate electrode 4. Thereby, the protruding portion 4a of the gate electrode, the strip portion 5a of the cathode electrode, and the cathode electrode 5 are obtained. At this time, the electroconductive material is deposited so as to form the pattern as illustrated in FIG. 4B to form the electron emitting portion 12 in the present embodiment. The electroconductive material may be any material as long as the material has electroconductivity and can conduct field emission, and generally can be a material which has a melting point of 2,000° C. or higher and a working function of 5 eV or less, and hardly forms a chemical reaction layer such as an oxide thereon or forms a reaction layer thereon which can be easily removed therefrom. Such materials include, for instance: metals such as Hf, V, Nb, Ta, Mo, W, Au, Pt and Pd or alloy materials thereof; carbides such as TiC, ZrC, HfC, TaC, SiC and WC; and borides such as HfB₂, ZrB₂, CeB₆, YB₄ and GdB₄. The materials also include: nitrides such as TiN, ZrN, HfN and TaN; and amorphous carbon, graphite, diamond like carbon, carbon having diamond dispersed therein and carbon compounds. A method to be employed for depositing the electroconductive material is a general vacuum film-forming technology such as a vapor deposition method and a sputtering method, and can be an EB vapor deposition. Although the length C of the strip portion 5a of the cathode electrode in the X-direction can be appropriately set, but can be in a range from several μm to several tens of μm.

### EXAMPLE

### Example 1

An example of the present invention will be described below.

(Step 1)

A blue plate glass was used as a substrate 1 and was sufficiently washed. Then, an Si₃N₄ film with the thickness of 300 nm was deposited thereon as an insulating layer 2 with a sputtering method (FIG. 9A).

(Step 2)

Next, SiO₂ was deposited with a sputtering method as an insulating layer 3 so as to have the thickness of 20 nm (FIG. 9B). Then, TaN was deposited thereon as an electroconductive layer 4 so as to have the thickness of 30 nm (FIG. 9C).

(Step 3)

Next, a positive-type photoresist was formed thereon by spin coating. Then, a photomask pattern was exposed to light, and the resist was developed thereby to form a resist pattern. At this time, the resist pattern was formed so that D=10 μm and S=12 μm could be satisfied. Subsequently, the insulating layer 2, the insulating layer 3 and the electroconductive layer 4 were dry-etched with the use of a CF₄ gas while the patterned photoresist was used as a mask, and the 1st insulating layer 2, the 2nd insulating layer 3 and the gate electrode 4 were formed. The dry etching operation was stopped right before the substrate 1 was etched, and a step structure was formed (FIG. 9D).

(Step 4)

Next, the 2nd insulating layer 3 was selectively etched by etching the formed step structure for 11 minutes while using a buffer hydrofluoric acid (BHF) (LAL100/made by Stella Chemifa Corp.) as an etching solution. The 2nd insulating layer 3 was etched from the side wall of the step portion by about 60 nm, and the recess part 7 was formed (FIG. 9E).

(Step 5)

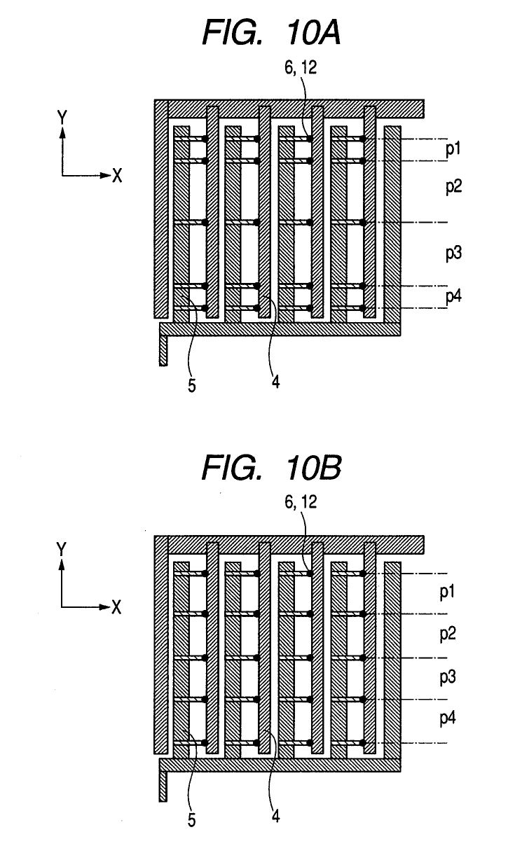

Next, in order to form the protruding portion 4a of the gate electrode, the strip portion 5a of the cathode electrode and the cathode electrode 5, Mo was selectively deposited with a method of vapor-depositing Mo from a diagonally 45 degrees upper part so as to have a thickness of 30 nm. At that time, the resist pattern was formed so that C=10 μm (FIG. 9F), and p1=10 μm, p2=50 μm, p3=50 μm and p4=10 μm (FIG. 10A) could be satisfied.

### Comparative Example 1

The present comparative example differed from Example 1 only in the Step 5. Other steps were the same as in Example 1. In the Step 5, in order to form the gate electrode, the cathode electrode and a bus wire of the cathode electrode, Mo was selectively deposited with a method of vapor-depositing Mo from a diagonally 45 degrees upper part so as to have a thickness of 30 nm. At that time, the resist pattern was formed so that C=10 μm (FIG. 9F), and p1=30 μm, p2=30 μm, p3=30 μm and p4=30 μm (FIG. 10B) could be satisfied.

In any example, the distance between the face plate and the rear plate was set at 1.6 mm, the anode voltage at 12 kV, the potential between the gate and the cathode at 20V, and the width w of the light-emitting member 44 at 180 μm.

In the example, ΔYL/ΔYB in ΔYB=20 μm was 0.37. In the comparative example, ΔYL/ΔYB in ΔYB=20 μm was 0.55. Thus, in the present example, the variation of the luminance gravity center due to the deflection of an electron beam could be reduced.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-148633, filed on Jun. 23, 2009, which is hereby incorporated by reference herein in its entirety.

What is claimed is:

1. An image display apparatus comprising:
an electron-emitting device having a gate electrode and a cathode electrode having a plurality of strip portions each arranged in opposition to the gate electrode to form a gap portion between the each of the strip portions and the gate electrode, wherein each of the gap portions functions as an electron emitting portion according to a potential difference between a gate potential applied to the gate electrode and a cathode potential applied to the cathode electrode; and
a light-emitting member for emitting light responsive to an irradiation with an electron emitted from the electron emitting portion, wherein
the plurality of strip portions are arranged in line along a predetermined direction, and
a distance between the strip portions adjacent to each other in a center area in the electron-emitting device is longer than a distance between the strip portions adjacent to each other in a peripheral area in the electron-emitting device.

2. The image display apparatus according to claim 1, wherein
a length of a range irradiated with the electron emitted from the electron-emitting device is longer than a length of the light-emitting member, in a direction of arranging the plurality of strip portions.

3. The image display apparatus according to claim 1, wherein
the gate electrode has a plurality of protruding portions, and a width of the protruding portion of the gate electrode is smaller than a width of the strip portion of the cathode electrode.

4. An image display apparatus comprising:
an electron-emitting device having a gate electrode and a cathode electrode having a plurality of strip portions each arranged in opposition to the gate electrode to form a gap portion between the each of the strip portions and the gate electrode, wherein each of the gap portions functions as an electron emitting portion according to a potential difference between a gate potential applied to the gate electrode and a cathode potential applied to the cathode electrode; and
a light-emitting member for emitting light responsive to an irradiation with an electron emitted from the electron emitting portion, wherein
the plurality of strip portions are arranged such that the electron emitting portions are distributed at a lower density in a center area in the electron-emitting device and are distributed at a higher density in a peripheral area in the electron-emitting device.

5. An image display apparatus comprising:
an electron-emitting device having a gate electrode and a cathode electrode having a plurality of strip portions each arranged in opposition to the gate electrode to form a gap portion between the each of the strip portions and the gate electrode, wherein each of the gap portions functions as an electron emitting portion according to a potential difference between a gate potential applied to the gate electrode and a cathode potential applied to the cathode electrode; and
a light-emitting member for emitting light responsive to an irradiation with an electron emitted from the electron emitting portion, wherein
the plurality of strip portions are arranged in a matrix along a plurality of rows and columns, and
a distance between the strip portions adjacent to each other in a center area in the electron-emitting device is longer than a distance between the strip portions adjacent to each other in a peripheral area in the electron-emitting device.

6. An image display apparatus comprising:
an electron-emitting device having a plurality of gate electrodes each arranged along column direction and a plurality of cathode electrodes each arranged along column direction, wherein the cathode electrode has a plurality of strip portions each arranged in opposition to the gate electrode to form a gap portion between the each of the strip portions and the gate electrode, and wherein each of the gap portions functions as an electron emitting portion according to a potential difference between a gate potential applied to the gate electrode and a cathode potential applied to the cathode electrode; and
a light-emitting member for emitting light responsive to an irradiation with an electron emitted from the electron emitting portion, wherein
the plurality of strip portions are arranged in a matrix along a plurality of rows and columns, and
a distance between the strip portions adjacent to each other in a center area in the electron-emitting device is longer than a distance between the strip portions adjacent to each other in a peripheral area in the electron-emitting device.
